(19) United States
(12) Patent Application Publication
(10) Pub. No.: US 2026/0331025 A1
(43) Pub. Date: Oct. 22, 2026

(54) DATA TRANSMISSION AND RECEPTION DEVICE AND DISPLAY DEVICE INCLUDING THE SAME

(71) Applicant: LX Semicon Co., Ltd., Daejeon (KR)

(72) Inventors: Hyun Pyo CHO, Daejeon (KR); Kwang Hee YOON, Daejeon (KR)

(73) Assignee: LX Semicon Co., Ltd., Daejeon (KR)

(21) Appl. No.: 19/655,151

(22) Filed: Apr. 22, 2026

(30) Foreign Application Priority Data
Apr. 22, 2025 (KR) 10-2025-0052062

(51) Int. Cl. G09G 3/20

(52) U.S. Cl. CPC G09G 3/2096; G09G 2310/08

(57) ABSTRACT

Disclosed are a data transmission and reception device and a display device including the same. The data transmission and reception device includes a transmission device; a plurality of reception devices; a first communication line configured to connect the reception devices to the transmission device on one-to-one basis; and a second communication line configured to connect the transmission device and the reception devices between a first terminal and a second terminal of the transmission device. The transmission device is configured to transmit a first ID code to the first reception device via the forward wire of the second communication line and receive an ID assignment confirmation signal via the feedback wire of the second communication line connected to the n-th reception device.

### CROSS-REFERENCE TO RELATED APPLICATION

This application claims priority to and the benefit of Korean Patent Application No. 10-2025-0052062, filed in the Republic of Korea on April 22, 2025, the disclosure of which is incorporated herein by reference in its entirety.

### BACKGROUND

### Field

Embodiments relate to a technique for assigning an ID (Identifier) for identifying each of integrated circuits (ICs).

### Discussion of Related Art

A display panel includes multiple pixels arranged in a matrix. The respective pixels may have colors such as red (R), green (G), and blue (B), and display an image on the display panel while emitting light with grayscales according to image data.

The image data is transmitted from a data processing device such as a timing controller to a data driving device such as a source drive IC. The image data is transmitted as a digital value, and the data driving device converts the image data into an analog voltage to drive the respective pixels.

### SUMMARY

For bidirectional communication between a data processing device and a plurality of data driving device, a method is required to identify each of the data driving devices. Embodiments provide a data transmission and reception device capable of automatically assigning IDs for identifying source drive ICs to the respective integrated circuits (ICs) on a per-IC (Integrated Circuit) basis, on an individual IC basis, and a display device including the same.

The problems addressed by the present disclosure are not limited to those described above, and other problems not described will be clearly understood by those skilled in the art from the following description.

A data transmission and reception device according to one embodiment includes: a transmission device; a plurality of reception devices; a first communication line configured to connect the reception devices to the transmission device on one-to-one basis; and a second communication line configured to connect the transmission device and the reception devices between a first terminal and a second terminal of the transmission device. The second communication line includes: a forward wire connected between the first terminal of the transmission device and a first reception device; a feedback wire connected between an n-th (where n is a natural number equal to or greater than three) reception device and the second terminal of the transmission device; and one or more intermediate wires configured to connect adjacent reception devices between the first reception device and the n-th reception device. The transmission device is configured to transmit a first ID code to the first reception device via the forward wire and receive an ID assignment confirmation signal via the feedback wire connected to the n-th reception device.

The transmission device may output a clock training signal, control data, and image data after having received the ID assignment confirmation signal.

A signal transmission speed of the second communication line may be lower than a signal transmission speed of the first communication line.

The first reception device may generate a second ID code in response to the first ID code and transmit the second ID code to the n-th reception device via the intermediate wire. The n-th reception device may transmit the ID assignment confirmation signal to the transmission device via the feedback wire in response to the second ID code.

The first reception device may generate the second ID code by adding a preset amount of increase or decrease to the first ID code. The n-th reception device is configured to generate the ID assignment confirmation signal by adding the amount of increase or decrease to the second ID code.

The transmission device may transmit a start code to the first reception device via the forward wire prior to the first ID code and receive the start code from the n-th reception device via the feedback wire.

The first reception device may transmit the start code received via the forward wire to the n-th reception device via the intermediate wire, and then, change a voltage of the intermediate wire to a first voltage. The n-th reception device may transmit the start code received via the intermediate wire to the transmission device via the feedback wire, and then, change a voltage of the feedback wire to the first voltage.

The transmission device may transmit a preset pre-code to the first reception device via the forward wire prior to the start code.

The transmission device may transmit a stop code to the first reception device via the forward wire after the ID assignment confirmation signal has been received and receive the stop code from the n-th reception device via the feedback wire.

The first reception device may transmit the stop code received via the forward wire to the n-th reception device via the intermediate wire. The n-th reception device may transmit the stop code received via the intermediate wire to the transmission device via the feedback wire.

The first reception device may output the stop code to the intermediate wire, and then, change the voltage of the intermediate wire to a second voltage. The n-th reception device may output the stop code to the feedback wire, and then, change the voltage of the feedback wire to the second voltage.

The transmission device may transmit the clock training signal, the control data, and the image data to the reception devices via the first communication line through one-way communication. The transmission device and the reception devices may perform two-way communication via the second communication line.

A display device according to one embodiment includes: a display panel in which data lines connected to pixels are disposed; a plurality of drive ICs that are electrically connected to the data lines and are configured to supply a data voltage corresponding to image data to the data lines; and a timing controller connected to the drive ICs via a first communication line and a second communication line and configured to assign IDs to the drive ICs via the second communication line, and then, transmit the image data to the drive ICs via the first communication line. The first communication line is configured to connect the timing controller and the drive ICs on one-to-one basis. The second communication line is configured to connect the timing controller and the drive ICs in a cascade manner. The timing controller is configured to transmits a first ID code to one drive IC among the drive ICs.

The drive ICs may include: a first drive IC configured to generate an (n-1)th (where n is a natural number equal to or greater than three) ID code by adding a preset amount of increase or decrease to the first ID code received from the timing controller via the second communication line; an (n-1)th drive IC configured to generate an n-th ID code by adding the amount of increase or decrease to the (n-1)th ID code received via the second communication line; and an n-th drive IC configured to generate an ID assignment confirmation signal by adding the amount of increase or decrease to the n-th ID code received via the second communication line and transmit the ID assignment confirmation signal to the timing controller.

According to one or more embodiments, it is possible to assign an unique ID to each data driving device (RX system) via a communication channel transmission path connected between the data processing device (TX system) and a plurality of data driving devices (RX system) in a cascade manner.

According to one or more embodiment, it is possible to allow the TX system to set tests, debugging, or a transmission channel environment construction for each IC of the RX system using the unique ID assigned to each IC chip of the RX system.

According to one or more embodiments, it is possible to allow the TX system to request status information for each IC of the RX system using the ID assigned to each IC chip of the RX system, determine whether the IC is normal, on the basis of the status information received from the IC, and define and execute a subsequent operation.

The effects of the present disclosure are not limited to the effects described above, and other effects not described will be understood by those skilled in the art from the following description and the appended claims.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a configuration diagram of a display device according to an embodiment of the present disclosure;

FIG. 2 is a configuration diagram of a data processing device and a data driving device according to the embodiment of the present disclosure;

FIG. 3 is a diagram showing a first main communication part and a second main communication part according to the embodiment of the present disclosure;

FIG. 4 is a diagram showing signal transmission lines between the data processing device and the data driving device according to the embodiment of the present disclosure;

FIG. 5 is a flowchart illustrating a control procedure of an ID assignment step according to the embodiment of the present disclosure step by step; and

FIG. 6 is a waveform chart showing IDs that are sequentially assigned to source drive ICs in the ID assignment step according to the embodiment of the present disclosure.

### DETAILED DESCRIPTION OF EXEMPLARY EMBODIMENTS

The advantages and features of the present disclosure, and methods of achieving them will be apparent from the embodiments described in detail below in conjunction with the accompanying drawings. However, the present disclosure is not limited to the following embodiments, which may be implemented in various different forms; rather, the present embodiments are provided to make the disclosure of the present disclosure complete and to allow those skilled in the art to fully understand the scope of the present disclosure, and the present disclosure is defined only within the scope of the appended claims.

The shapes, sizes, proportions, angles, numbers and the like shown in the accompanying drawings for the purpose of describing the embodiments of the present disclosure are merely examples, and the present disclosure is not limited thereto. Like reference numerals generally denote like elements throughout the present specification. Further, in describing the present disclosure, detailed descriptions of known related technologies may be omitted so as not to unnecessarily obscure the subject matter of the present disclosure.

The following embodiments may be combined or associated with each other in whole or in part, and various types of interlocking and driving are technically possible. The embodiments may be implemented independently of each other or together in an interrelated relationship.

Various embodiments of the present disclosure will be described in detail with reference to the accompanying drawings.

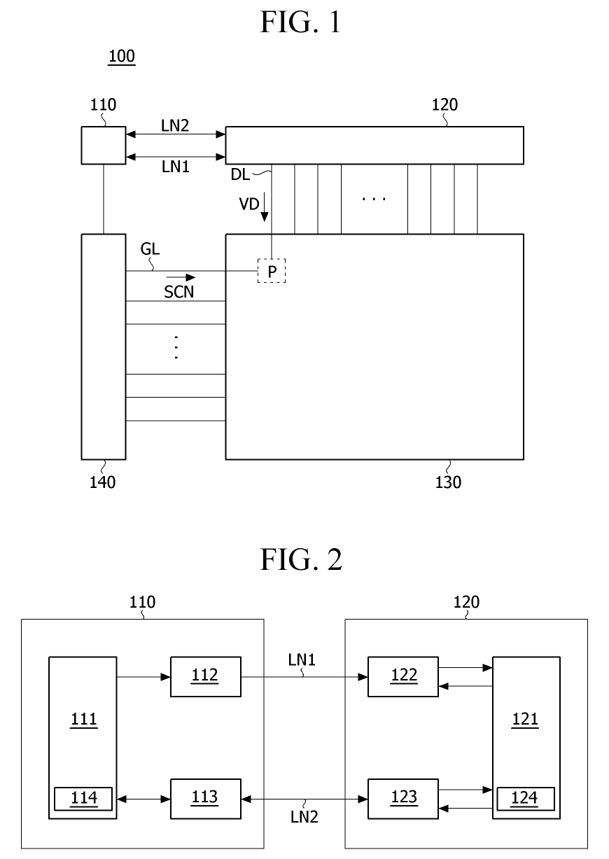

FIG. 1 is a configuration diagram of a display device according to an embodiment.

Referring to FIG. 1, a display device 100 may include a data processing device 110, a data driving device 120, a display panel 130, a gate driving device 140, and the like. The data processing device 110 may be interpreted as a transmission system (TX system) or device. The data driving device 120 may be interpreted as a reception system (RX system) or device.

The data processing device 110 may receive image data from another device. Another device is a device that generates the image data and may be a host system connected to a video source.

The data processing device 110 may process the image data received from another device to fit the data driving device 120 and may transmit the processed image data to the data driving device 120. The data processing device 110 may perform gamma correction processing on grayscale values of respective pixels included in the image data or may perform compensation processing to fit the characteristics of the respective pixels. The data processing device 110 may be a timing controller.

The data driving device 120 may receive the image data from the data processing device 110, may generate a data voltage VD according to the grayscale values of the pixels included in the image data, and may supply the data voltage VD to the pixels P. The data driving device 120 may include a plurality of source drive ICs electrically connectable to data lines DL of the display panel 130.

In the display panel 130, multiple pixels P may be disposed. Each pixel P may be connected to the data driving device 120 via the data line DL and may be connected to the gate driving device 140 via a gate line GL.

The display panel 130 may be a panel of a flat panel display such as a liquid crystal display (LCD), a field emission display (FED), a plasma display panel (PDP), an organic light emitting display (OLED), or a non-organic light emitting display.

A transistor may be disposed in each pixel P, a gate terminal of the transistor may be connected to the gate line GL, and a source terminal of the transistor may be connected to the data line DL. When the gate driving device 140 supplies a scan signal SCN to the gate line GL, the transistor is turned on, and the data line DL is connected to the pixel P. After the data line DL is connected to the pixel P, the data voltage VD supplied from the data driving device 120 is transmitted to the pixel P.

The data processing device 110 transmits a timing control signal to the driving device 140 and the data driving device 120 to synchronize the gate driving device 140 and the data driving device 120, and controls an operation timing of each of the gate driving device 140 and the data driving device 120.

The data processing device 110 may transmit a gate timing control signal to the gate driving device 140. The gate driving device 140 may generate the scan signal SCN according to the gate timing control signal and may supply the scan signal SCN to the pixel P via the gate line GL.

At least two kinds of communication lines LN1 and LN2 may be disposed between the data processing device 110 and the data driving device 120. The data processing device 110 may transmit a first signal via a first communication line LN1 and may transmit or receive a second signal via the second communication line LN2.

The first communication line LN1 may form a one-way high-speed communication channel, and the second communication line LN2 may form a two-way low-speed communication line. The first communication line LN1 may be interpreted as a main communication line or a main channel. The second communication line LN2 may be interpreted as an auxiliary communication line, an auxiliary channel, or the like. The first signal may be interpreted as a main communication signal, and the second signal may be interpreted as an auxiliary communication signal.

The data processing device 110 may transmit control data and the image data to the data driving device 120 via the first communication line LN1 in a display mode. The control data may include timing control information of the data driving device 120 and the gate driving device 140, option information, and the like. In an ID assignment data before entering the display mode, the driving device 120 receives and stores ID codes received via the second communication line LN2. The plurality of source drive ICs that compose the data driving device 120 are sequentially assigned with IDs according to the ID codes received via the second communication line LN2, and a last source drive IC may store the own ID code, and then, may transmit a signal indicating the end of ID assignment to the data processing device 110 via the second communication line LN2.

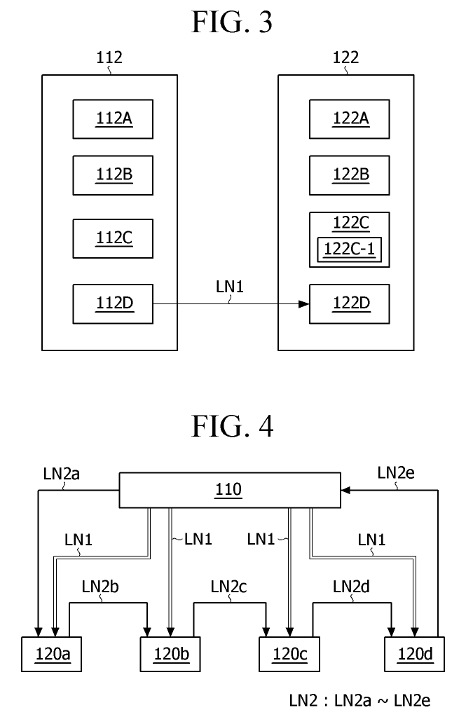

FIG. 2 is a configuration diagram of the data processing device and the data driving device according to the embodiment of the present disclosure. FIG. 3 is a diagram showing a first main communication part and a second main communication part according to the embodiment of the present disclosure.

Referring to FIGS. 2 and 3, the data processing device 110 may include a transmission controller 111, a first main communication part 112, a first auxiliary communication part 113, and the like. The data driving device 120 may include a reception controller 121, a second main communication part 122, a second auxiliary communication part 123, and the like.

The first main communication part 112 and the second main communication part 122 may be connected via the first communication line LN1. The first main communication part 112 may transmit the control data, the image data, and the like to the second main communication part 122 via the first communication line LN1 in the display mode.

The first main communication part 112 may transmit a clock training signal for clock and data recovery (CDR) of the data driving device 120 to the second main communication part 122 via the first communication line LN1. A clock training step in which the clock training signal is transmitted to the data driving device 120 may be performed between the ID assignment step and the display mode. The clock training signal may be transmitted to the data driving device 120 via the first communication line LN1. When a signal indicating a lock fail state of the data driving device 120 is received by the data processing device 110, the data processing device 110 transmits the clock training signal to the first communication line LN1 to restart the CDR.

The first auxiliary communication part 113 and the second auxiliary communication part 123 may be connected via the second communication line LN2. The first auxiliary communication part 113 may transmit the ID codes to the second auxiliary communication part 123 via the second communication line LN2 in the ID assignment step.

The first main communication part 112 may include a scrambler 112A, an encoder 112B, a parallel to serial (P2S) converter 112C, a transmitter 112D, and the like. The second main communication part 122 may include a receiver 122D, a serial to parallel (S2P) converter 122C, a decoder 122B, a de-scramble 122A, and the like.

The image data is scrambled by the scrambler 112A. Scrambling is a process of scrambling respective bits of data to be transmitted, so that the same bits can be prevented from being placed consecutively in a transmission stream of data K (where K is a natural number equal to or greater than two) times or more. Since scrambling may be performed according to pre-arranged rules, the de-scramble 122A can perform a function of restoring a stream in which the respective bits are scrambled, back to data in an original state.

The encoder 112B may encode P bits in the transmission stream of data into Q bits. P may be, for example, eight, and Q may be, for example, ten. Encoding eight-bit data into ten-bit data is defined as 8B10B encoding. The 8B10B encoding is a kind of encoding method with a DC balance code. According to the embodiment, it is possible improve image defects by encoding not only the image data but also control data for one horizontal line to increase a data restoration rate.

The encoder 112B may encode data such that the bits of the transmission stream increase. Encoded data may be decoded with the DC balance code, for example, 8B10B by the decoder 122B. In another aspect, the encoded data may be restored to the original bits by the decoder 122B.

The encoder 112B may use a limited run length code (LRLC) in encoding of data. "Run Length" means that the same bits are placed consecutively, and the LRLC controls specific bits in the middle of data such that "Run Length" does not appear more than a given size in data. When the encoder 112B encodes data using the LRLC, the decoder 122B may decode data according to the LRLC scheme used by the encoder 112B.

The P2S converter 112C converts data in a parallel system into data in a serial transmission system such that a signal can be transmitted via a small number of wires of the first communication line LN1. The transmitter 112D may serially transmit data input from the P2S converter 112C via the first communication line LN1. The data that is transmitted via the first communication line LN1 may be a differential signal. In this case, the first communication line LN1 may include a wire for transmitting a positive polarity signal and a wire for transmitting a negative polarity signal.

The S2P converter 122C converts received serial data into parallel data. The S2P converter 122C may include a clock recovery part 122C-1. The clock recovery part 122C-1 receives the clock training signal, performs clock training, so that a phase of a clock detected from an input signal is stably fixed, and then, samples bits of data with the clock recovered in this manner to restore the control data and the image data. The clock restoration part 122C-1 may recover the clock by a phase locked loop (PLL) method, but embodiments of the present disclosure are not limited thereto. For example, the clock recovery part may recover the clock by a delay-locked loop (DLL) method.

The transmission controller 111 may include a memory 114. The memory 114 may store an ID code of a first source drive IC that will be first assigned with an ID, among a plurality of source drive ICs the data driving device 120.

The reception controller 121 of each source drive IC includes a memory 124. The memory 124 stores the received ID code. The first source drive IC stores the ID code thereof received from the data processing device 110 in the memory 124. Each of the source drive ICs other than the first source drive IC receives an ID code received from another source drive IC early assigned with the ID and stores the ID code in the memory.

FIG. 4 is a diagram showing signal transmission wires between the data processing device and the data driving device according to the embodiment of the present disclosure. In FIG. 4, a third source drive IC 120c may be an (n-1)th source drive IC, and a fourth source drive IC 120d may be an n-th source drive IC.

Referring to FIG. 4, the data driving device may include a plurality of source drive ICs 120a, 120b, 120c, and 120d. The data processing device 110 may be connected to the source drive ICs 120a, 120b, 120c, and 120d via the first communication line LN1 on one-to-one basis.

The first communication line LN1 may be composed of m (where m is a natural number) lines electrically insulated from each other. Every two lines of the m lines may be paired, and low voltage differential signaling (LVDS) communication can be performed for each pair.

The data processing device 110 and the source drive ICs 120a, 120b, 120c, and 120d may be connected in a cascade manner or in series via the second communication line LN2 between a first terminal and a second terminal of the data processing device 110.

The second communication line LN2 may include a forward wire (LN2a) n (where n is a natural number equal to or greater than two) intermediate wires LN2b, LN2c, and LN2d, and a feedback wire LN2e. In FIG. 4, a case where n is three is illustrated, but embodiments of the present disclosure are not limited thereto. Because adjacent source drive ICs are connected via the intermediate wire, as the number of source drive ICs increases, the number of intermediate wires becomes greater.

A first source drive IC 120a is connected to the first terminal of the data processing device 110 via the forward wire LN2a. The first source drive IC 120a and a second source drive IC 120b connected to each other via a first intermediate wire LN2b. The second source drive IC 120b and a third source drive IC 120c are connected to each other via a second intermediate wire LN2c. The third source drive IC 120c and a fourth source drive IC 120d are connected to each other via a third intermediate wire LN2d. The fourth source drive IC 120d is connected to the second terminal of the data processing device 110 via the feedback wire LN2e.

In the clock training step, the data processing device 110, for example, the timing controller may transmit the clock training signal to the source drive ICs 120a, 120b, 120c, and 120d via the first communication line LN1. When a first voltage of a lock signal is received via the forward wire LN2a, the lock signal may be output at the first voltage when a phase of a clock recovered by the first source drive IC 120a performing clock training is fixed. The first voltage of the lock signal output from the first source drive IC 120a is transmitted (propagates) to the second source drive IC 120b via the first intermediate wire LN2b. When a phase of a clock recovered by the second source drive IC 120b performing clock training is fixed, the lock signal may be output at the first voltage. The first voltage of the lock signal output from the second source drive IC 120b is transmitted to the third source drive IC 120c via the second intermediate wire LN2c. When a phase of a clock recovered by the third source drive IC 120c performing clock training is fixed, the lock signal may output at the first voltage. The first voltage of the lock signal output from the third source drive IC 120c is transmitted to the fourth source drive IC 120d via the third intermediate wire LN2d. When a phase of a clock recovered by the fourth source drive IC 120d performing clock training is fixed, the lock signal may be output at the first voltage. The first voltage of the lock signal output from the fourth source drive IC 120d is transmitted to the data processing device 110 via the feedback wire LN2e. When the phase of the restored clock is unlocked in any of the source drive ICs 120a, 120b, 120c, and 120d, the lock signal is inverted at a second voltage to indicate a lock fail state and is transmitted to the data processing device 110. The lock fail state refers to a state in which a clock is not normally recovered in the source drive ICs 120a, 120b, 120c, and 120d. The data processing device 110 may enter the display mode when the lock signal received via the feedback wire LN2e is at the first voltage, and may transmit the clock training signal to the source drive ICs 120a, 120b, 120c, and 120d when the lock signal is at the second voltage. The first voltage of the lock signal may be a high voltage High or H of a digital signal, the second voltage may be a low voltage Low or L of a digital signal, but embodiments of the present disclosure are not limited thereto.

In the ID assignment step, the IDs may be sequentially assigned to the source drive ICs 120a, 120b, 120c, and 120d by the ID codes sequentially transmitted to the source drive ICs 120a, 120b, 120c, and 120d via the second communication line LN2 and each IC may be given the unique ID. The ID assignment step will be described in detail below in connection with FIGS. 4, 5, and 6.

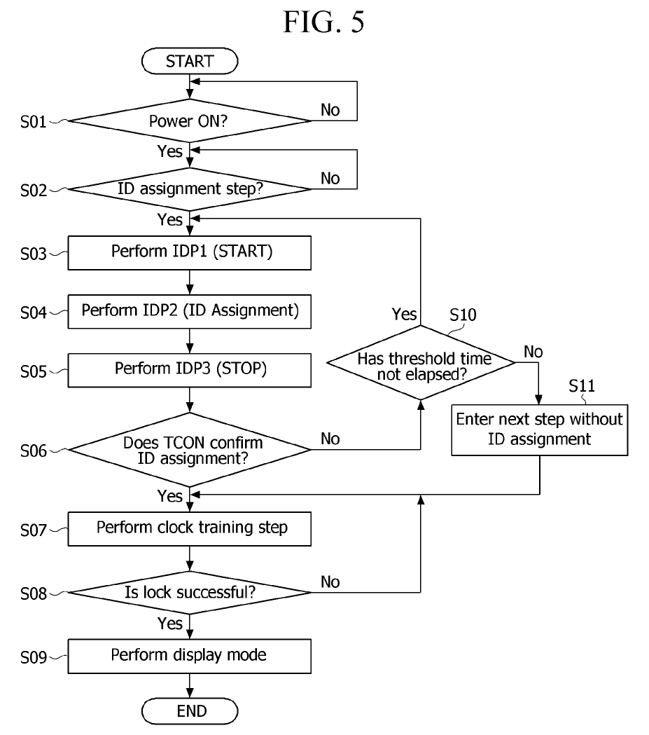

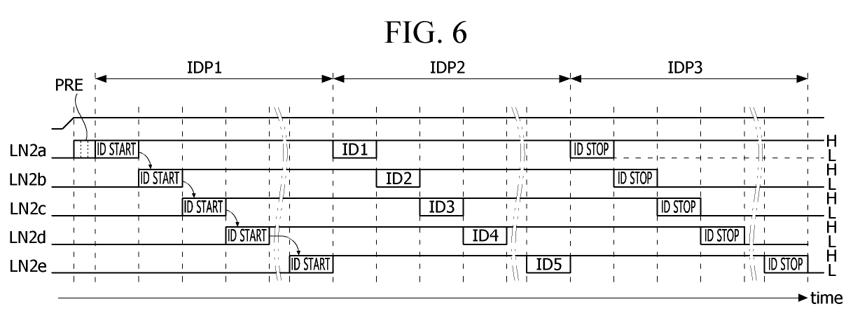

FIG. 5 is a flowchart illustrating a control procedure of the ID assignment step according to the embodiment of the present disclosure step by step. In FIG. 5, "TCON" represents a timing controller as an example of the data processing device 110. FIG. 6 is a waveform chart showing IDs that are sequentially assigned to the source drive ICs in the ID assignment step according to the embodiment of the present disclosure.

Referring to FIGS. 4, 5, and 6, when power is applied to the display device, the timing controller TCON and the source drive ICs 120a, 120b, 120c, and 120d start to be driven. Immediately after power is applied to the display device, the timing controller TCON may enter the ID assignment step (S01, S02).

The ID assignment step may be performed dividedly into a first period IDP1 during which an ID assignment start protocol is performed for the source drive ICs 120a, 120b, 120c, and 120d, a second period IDP2 during which the IDs are sequentially assigned to the source drive ICs 120a, 120b, 120c, and 120d, and a third period IDP3 during which an ID assignment stop protocol is performed for the source drive ICs 120a, 120b, 120c, and 120d (S03, S04, S05).

When the first period IDP1 starts, the timing controller TCON transmits a start code ID START to the first source drive IC 120a via the forward wire LN2a. The start code ID START is digital data defined in the ID assignment start protocol. A pre-code PRE may be transmitted to the first source drive IC 120a prior to the start code ID START. The pre-code PRE may include a pulse that is generated at a specific voltage, for example, the high voltage H or is toggled one time or more and voltage-inverted one time or more. The pre-code PRE can improve a recognition rate of the start code ID START in the first source drive IC 120a in a communication link of the timing controller TCON and the first source drive IC 120a. After the first source drive IC 120a receives the start code ID START, the start code ID START is sequentially transmitted (propagates) to other source drive ICs 120b, 120c, and 120d.

The first source drive IC 120a transmits the start code ID START received from the timing controller TCON to the second source drive IC 120b via the first intermediate wire LN2b, and then, changes a voltage of the first intermediate wire LN2b from the low voltage L to the high voltage H. The second source drive IC 120b transmits the start code ID START received from the first source drive IC 120a to the third source drive IC 120c via the second intermediate wire LN2c, and then, changes a voltage of the second intermediate wire LN2c from the low voltage L to the high voltage H. The third source drive IC 120c transmits the start code ID START received from the second source drive IC 120b to the fourth source drive IC 120d via the third intermediate wire LN2d, and then, changes a voltage of the third intermediate wire LN2d from the low voltage L to the high voltage H. The fourth source drive IC 120d transmits the start code ID START received from the third source drive IC 120c to the timing controller TCON via the feedback wire LN2e, and then, changes a voltage of the feedback wire LN2e from the low voltage L to the high voltage H.

The timing controller TCON determines that the ID assignment start protocol is normally performed when the start code ID START is received from the fourth source drive IC 120d via the feedback wire LN2e, and enters the ID assignment step. The ID assignment step is performed in the second period IDP2 (S04). In the ID assignment step, the first source drive IC 120a may generate a second ID code in response to the first ID code received from the timing controller TCON. An n-th source drive IC may generate an ID assignment confirmation signal in response to an n-th ID code received from an (n-1)th source drive IC and may provide the ID assignment confirmation signal to the timing controller TCON.

When the second period IDP2 starts, the timing controller TCON transmits a first ID code ID1 to the first source drive IC 120a via the forward wire LN2a. The timing controller TCON may apply the high voltage H to the forward wire LN2a after having transmitted the first ID code ID1 to the first source drive IC 120a. The first ID code ID1 is digital data defined in an ID assignment protocol. The first source drive IC 120a stores the first ID code ID1 received via the forward wire LN2a in the memory 124, assigns the first ID code ID1 as the ID for the first source drive IC 120a, and generates a second ID code ID2 by adding a preset amount of increase or decrease to the first ID code ID1. The first source drive IC 120a transmits the second ID code ID2 to the second source drive IC 120b via the first intermediate wire LN2b. The second source drive IC 120b stores the second ID code ID2 received via the first intermediate wire LN2b in the memory 124, assigns the second ID code ID2 as the ID of the second source drive IC 120b, and generates a third ID code ID3 by adding an amount of increase or decrease to the second ID code ID2. The second source drive IC 120b transmits the third ID code ID3 to the third source drive IC 120c via the second intermediate wire LN2c. The third source drive IC 120c stores the third ID code ID3 received via the second intermediate wire LN2c in the memory 124, assigns the third ID code ID3 as the ID of the third source drive IC 120c, and generates a fourth ID code ID4 by adding an amount of increase or decrease to the third ID code ID3. The third source drive IC 120c transmits the fourth ID code ID4 via the third intermediate wire LN2d to the fourth source drive IC 120d. The fourth source drive IC 120d stores the fourth ID code ID4 received via the third intermediate wire LN2d in the memory 124, assigns the fourth ID code ID4 as the ID of the fourth source drive IC 120b, and generates a fifth ID code ID5 by adding an amount of increase or decrease to the fourth ID code ID4. The fifth ID code ID5 may be interpreted as the ID assignment confirmation signal. The fourth source drive IC 120d transmits the fifth ID code ID5 to the timing controller TCON via the feedback wire LN2e. In the ID assignment step, each of the source drive ICs 120a, 120b, 120c, and 120d may apply the high voltage H to the corresponding wire of the wires LN2b, LN2c, LN2d, and LN2e for transmitting the ID code after having output the ID code generated inside. The amount of increase or decrease added to the ID code in each of the source drive ICs 120a, 120b, 120c, and 120d may be the same value in the respective ICs, for example, "+1", but embodiments of the present disclosure are not limited thereto. For example, when ID1 = 1, the ID codes generated in the source drive ICs 120a, 120b, 120c, and 120d may be ID2 = ID1 + 1 = 2, ID3 = ID2 + 1 = 3, ID4 = ID3 + 1 = 4, and ID5 = ID4 + 1 = 5.

The timing controller TCON determines that the ID assignment protocol is normally performed when the fifth ID code ID5 is received from the fourth source drive IC 120d via the feedback wire LN2e, and enters an ID assignment stop step to end the ID assignment (S05).

In the ID assignment stop step is performed in the third period IDP3. The timing controller TCON may ascertain the number of source drive ICs 120a, 120b, 120c, and 120d to which the ID is assigned, and may also verify whether the ID assignment is normally performed, according to a data value of the fifth ID code ID5 received via the feedback wire LN2e. For example, the timing controller TCON may confirm whether the ID assignment protocol is normally performed by comparing the fifth ID code ID5 stored in the memory 114 with the fifth ID code ID5 received via the feedback wire LN2e. The timing controller TCON may perform the ID assignment step S04 again when the fifth ID code ID5 received via the feedback wire LN2e does not match the fifth ID code ID5 stored in the memory 114.

When the third period IDP3 starts, the timing controller TCON transmits as a stop code ID STOP to the first source drive IC 120a via the forward wire LN2a. The stop code ID STOP is digital data defined in an ID assignment stop protocol. The timing controller TCON may control the voltage of the forward wire LN2a at a voltage defined in the ID assignment stop protocol, for example, the high voltage H or the low voltage L after having output the stop code ID STOP. After the first source drive IC 120a receives the stop code ID STOP, the stop code ID STOP is sequentially transmitted (propagates) to other source drive ICs 120b, 120c, and 120d.

The first source drive IC 120a transmits the stop code ID STOP received from the timing controller TCON to the second source drive IC 120b via the first intermediate wire LN2b, and then, changes the voltage of the first intermediate wire LN2b from the high voltage H to the low voltage L. The second source drive IC 120b transmits the stop code ID STOP received from the first source drive IC 120a to the third source drive IC 120c via the second intermediate wire LN2c, and then, changes the voltage of the second intermediate wire LN2c from the high voltage H to the low voltage L. The third source drive IC 120c transmits the stop code ID STOP received from the second source drive IC 120b to the fourth source drive IC 120d via the third intermediate wire LN2d, and then, changes the voltage of the third intermediate wire LN2d from the high voltage H to the low voltage L. The fourth source drive IC 120d transmits the stop code ID STOP received from the third source drive IC 120c to the timing controller TCON via the feedback wire LN2e, and then, changes the voltage of the feedback wire LN2e from the high voltage H to the low voltage L.

The timing controller TCON determines that the ID assignment stop protocol is normally performed when the stop code ID STOP is received from the fourth source drive IC 120d via the feedback wire LN2e, and performs the clock training step for establishing a communication link with the source drive ICs 120a, 120b, 120c, and 120d (S06, S07).

The timing controller TCON transmits the clock training signal to the source drive ICs 120a, 120b, 120c, and 120d via the first communication line LN1 in the clock training step, performs monitoring via the feedback wire LN2e, and when successful lock is confirmed, enters the display mode (S08, S09). The timing controller TCON transmits the control data and the image data to the source drive ICs 120a, 120b, 120c, and 120d in the display mode.

The timing controller TCON may monitor the voltage received via the feedback wire LN2e in Steps S04 and S05 and may perform the ID assignment (S03, S04, S05) again when the voltages of the signals defined in the ID assignment protocol and the ID assignment stop protocol are not received within a preset threshold time and the ID assignment is not confirmed (S10). The timing controller TCON does not perform the ID assignment (S03, S04, S05) again when the ID assignment is not confirmed until the threshold time elapses, and enters the clock training step (S11).

The timing controller TCON may discriminately access the source drive ICs 120a, 120b, 120c, and 120d using the unique ID assigned to each IC chip after the unique IDs are assigned to the respective source drive ICs 120a, 120b, 120c, and 120d. The timing controller TCON may separately process tests, debugging, or a transmission channel environment construction using the ID by discriminating the source drive ICs 120a, 120b, 120c, and 120d. For example, the timing controller TCON may transmit a status information request command via the forward wire LN2a along with the second ID code ID2. In this case, the second source drive IC 120b among the source drive ICs 120a, 120b, 120c, and 120d confirms the received second ID code ID2 and outputs status information of the second source drive IC 120b via the third intermediate wire LN2d in response to the command of the timing controller TCON. The timing controller TCON may receive the status information of the second source drive IC 120b via the feedback wire LN2e.

As an example of the transmission channel environment construction, the timing controller TCON may perform equalizer (EQ) setting for improving the quality of a transmission signal or set channel coding selection and selection of the number of channels in each of the source drive ICs 120a, 120b, 120c, and 120d along with the ID code. Channel coding may include scramble coding selection, CDR setting, and the like.

The first communication line LN1 is a high-speed communication channel transmission path between the timing controller TCON and the source drive ICs 120a, 120b, 120c, and 120d. In contrast, the second communication line LN2 is a low-speed communication channel transmission path between the timing controller TCON and the source drive ICs 120a, 120b, 120c, and 120d. The communication channel via the second communication line LN2 may support a transmission speed much lower than the first communication line LN1, for example, a transmission speed of 1 [Mbps] to 800 [Mbps]. In the above-described embodiment, because the IDs are assigned to the source drive ICs 120a, 120b, 120c, and 120d using the low-speed communication channel transmission path, it is possible to stably assign the ID with almost no communication errors.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A data transmission and reception device comprising:
a transmission device;
a plurality of reception devices;
a first communication line configured to connect the reception devices to the transmission device on one-to-one basis; and
a second communication line configured to connect the transmission device and the reception devices between a first terminal and a second terminal of the transmission device,
wherein the second communication line includes:
a forward wire connected between the first terminal of the transmission device and a first reception device;
a feedback wire connected between an n-th (where n is a natural number equal to or greater than three) reception device and the second terminal of the transmission device; and
one or more intermediate wires configured to connect adjacent reception devices between the first reception device and the n-th reception device, and
wherein the transmission device is configured to transmit a first ID code to the first reception device via the forward wire and receive an ID assignment confirmation signal via the feedback wire connected to the n-th reception device.

2. The data transmission and reception device according to claim 1, wherein the transmission device is configured to output a clock training signal, control data, and image data after having received the ID assignment confirmation signal.

3. The data transmission and reception device according to claim 1, wherein a signal transmission speed of the second communication line is lower than a signal transmission speed of the first communication line.

4. The data transmission and reception device according to claim 1, wherein:
the first reception device is configured to generate a second ID code in response to the first ID code and transmit the second ID code to the n-th reception device via the intermediate wire, and
the n-th reception device is configured to transmit the ID assignment confirmation signal to the transmission device via the feedback wire in response to the second ID code.

5. The data transmission and reception device according to claim 4, wherein:
the first reception device is configured to generate the second ID code by adding a preset amount of increase or decrease to the first ID code, and
the n-th reception device is configured to generate the ID assignment confirmation signal by adding the amount of increase or decrease to the second ID code.

6. The data transmission and reception device according to claim 1, wherein the transmission device is configured to transmit a start code to the first reception device via the forward wire prior to the first ID code and receive the start code from the n-th reception device via the feedback wire.

7. The data transmission and reception device according to claim 6, wherein:
the first reception device is configured to transmit the start code received via the forward wire to the n-th reception device via the intermediate wire, and then, change a voltage of the intermediate wire to a first voltage, and
the n-th reception device is configured to transmit the start code received via the intermediate wire to the transmission device via the feedback wire, and then, change a voltage of the feedback wire to the first voltage.

8. The data transmission and reception device according to claim 7, wherein the transmission device is configured to transmit a preset pre-code to the first reception device via the forward wire prior to the start code.

9. The data transmission and reception device according to claim 8, wherein the transmission device is configured to transmit a stop code to the first reception device via the forward wire after the ID assignment confirmation signal has been received and receive the stop code from the n-th reception device via the feedback wire.

10. The data transmission and reception device according to claim 9, wherein:
the first reception device is configured to transmit the stop code received via the forward wire to the n-th reception device via the intermediate wire, and
the n-th reception device is configured to transmit the stop code received via the intermediate wire to the transmission device via the feedback wire.

11. The data transmission and reception device according to claim 10, wherein:
the first reception device is configured to output the stop code to the intermediate wire, and then, change the voltage of the intermediate wire to a second voltage, and
the n-th reception device is configured to output the stop code to the feedback wire, and then, change the voltage of the feedback wire to the second voltage.

12. The data transmission and reception device according to claim 2, wherein:
the transmission device is configured to transmits the clock training signal, the control data, and the image data to the reception devices via the first communication line through one-way communication, and
the transmission device and the reception devices perform two-way communication via the second communication line.

13. A display device comprising:
a display panel in which data lines connected to pixels are disposed;
a plurality of drive ICs that are electrically connected to the data lines and are configured to supply a data voltage corresponding to image data to the data lines; and
a timing controller connected to the drive ICs via a first communication line and a second communication line and configured to assign IDs to the drive ICs via the second communication line, and then, transmit the image data to the drive ICs via the first communication line,
wherein the first communication line is configured to connect the timing controller and the drive ICs on one-to-one basis,
the second communication line is configured to connect the timing controller and the drive ICs in a cascade manner, and
the timing controller is configured to transmit a first ID code to one drive IC among the drive ICs.

14. The display device according to claim 13, wherein the drive ICs include:
a first drive IC configured to generate an (n-1)th (where n is a natural number equal to or greater than three) ID code by adding a preset amount of increase or decrease to the first ID code received from the timing controller via the second communication line;
an (n-1)th drive IC configured to generate an n-th ID code by adding the amount of increase or decrease to the (n-1)th ID code received via the second communication line; and
an n-th drive IC configured to generate an ID assignment confirmation signal by adding the amount of increase or decrease to the n-th ID code received via the second communication line and transmit the ID assignment confirmation signal to the timing controller.

15. The display device according to claim 14, wherein the second communication line includes:
a forward wire connected between a first terminal of the timing controller and a first drive IC;
a feedback wire connected between the n-th drive IC and a second terminal of the timing controller; and
one or more intermediate wires configured to connect adjacent drive ICs between the first drive IC and the n-th drive IC, and
wherein the timing controller is configured to transmit the first ID code to the first drive IC via the forward wire and receive the ID assignment confirmation signal via the feedback wire connected to the n-th drive IC.

16. The display device according to claim 14, wherein:
the timing controller is configured to transmit a clock training signal, control data, and image data via the first communication line through one-way communication after having received the ID assignment confirmation signal, and
the timing controller and the drive ICs perform two-way communication via the second communication line.

17. The display device according to claim 13, wherein a signal transmission speed of the second communication line is lower than a signal transmission speed of the first communication line.

18. The display device according to claim 15, wherein:
the first drive IC is configured to generate a second IC code in response to the first ID code and transmit the second IC code to the n-th drive IC via the intermediate wire, and
the n-th drive IC is configured to transmit the ID assignment confirmation signal to the timing controller via the feedback wire in response to the second ID code.

19. The display device according to claim 15, wherein the timing controller is configured to transmit a start code to the first drive IC via the forward wire prior to the first ID code and receive the start code from the n-th drive IC via the feedback wire.

20. The display device according to claim 19, wherein the first drive IC is configured to transmit the start code received via the forward wire to the n-th drive IC via the intermediate wire, and then, change a voltage of the intermediate wire to a first voltage, and
the n-th drive IC is configured to transmit the start code received via the intermediate wire to the timing controller via the feedback wire, and then, change a voltage of the feedback wire to the first voltage;
wherein the timing controller is configured to:
transmit a preset pre-code to the first drive IC via the forward wire prior to the start code, and
transmit a stop code to the first drive IC via the forward wire after the ID assignment confirmation signal has been received and receive the stop code from the n-th reception device via the feedback wire, and
wherein the first drive IC is configured to output the stop code to the intermediate wire, and then, change the voltage of the intermediate wire to a second voltage, and
the n-th drive IC is configured to output the stop code to the feedback wire, and then, change the voltage of the feedback wire to the second voltage.
